(19) United States
(12) Patent Application Publication
(10) Pub. No.: US 2018/0251221 A1
(43) Pub. Date: Sep. 6, 2018

(54) SELECTIVE PASSIVE RELEASE SYSTEM

(71) Applicant: Sikorsky Aircraft Corporation, Stratford, CT (US)

(72) Inventors: Ken Chu, Douglaston, NY (US); Matthew Genovese, Naugatuck, CT (US)

(21) Appl. No.: 15/561,429

(22) PCT Filed: Jan. 22, 2016
(86) PCT No.: PCT/US2016/014551

§ 371 Date: Sep. 25, 2017

Related U.S. Application Data
(60) Provisional application No. 62/138,462, filed on Mar. 26, 2015.

(51) Int. Cl. B64D 1/12

(52) U.S. Cl. CPC B64D 1/12

(57) ABSTRACT

A system and method to release a subject device includes a passage associated with the subject device, the passage having a first end and a second end, at least one hinged door associated with the second end of the passage, and at least one urging member to urge the at least one hinged door closed and to selectively open the at least one hinged door in response to the subject device contacting the at least one hinged door.

### FIELD OF THE INVENTION

The subject matter disclosed herein relates to releasing subject devices from an aircraft, and to a system and a method for selectively and passively releasing subject devices from an aircraft.

### DESCRIPTION OF RELATED ART

Modern aircraft, e.g. fixed wing aircraft, rotary wing aircraft, unmanned aerial vehicles, etc., can utilize deployable devices, such as sonobuoys, to obtain information from remote locations. Further, such deployable devices may need to be deployed from an aircraft during flight to reach intended locations. Deployment of such devices may require a passage from within the aircraft to outside the aircraft.

Aircraft may be sensitive to aerodynamic disturbances caused by such a passage to deploy devices. Electronic or other active mechanisms to selectively cover and uncover the passage may add additional cost, weight, and complexity to aircraft. A system and method that can selectively and passively deploy a subject device is desired.

### BRIEF SUMMARY

According to an embodiment of the invention, a selective passive release mechanism to release a subject device includes a passage associated with the subject device, the passage having a first end and a second end, at least one hinged door associated with the second end of the passage, and at least one urging member to urge the at least one hinged door closed and to selectively open the at least one hinged door in response to the subject device contacting the at least one hinged door.

In addition to one or more of the features described above, or as an alternative, further embodiments could include that the subject device has a subject weight.

In addition to one or more of the features described above, or as an alternative, further embodiments could include that the first end of the passage is associated with a subject device dispenser.

In addition to one or more of the features described above, or as an alternative, further embodiments could include that the at least one urging member is at least one torsion spring.

In addition to one or more of the features described above, or as an alternative, further embodiments could include that the subject device is a sonobuoy.

In addition to one or more of the features described above, or as an alternative, further embodiments could include that the selective passive release mechanism is associated with an aircraft.

In addition to one or more of the features described above, or as an alternative, further embodiments could include that the at least one hinged door is urged closed by the at least one urging member in response to at least one of an aerodynamic force, and an aircraft acceleration.

According to an embodiment of the invention, a method for selectively releasing a subject device includes, providing a passage associated with the subject device, the passage having a first end and a second end, providing at least one hinged door associated with the second end of the passage, urging the at least one hinged door closed via at least one urging member, selectively opening the at least one hinged door in response to the subject device contacting the at least one hinged door.

In addition to one or more of the features described above, or as an alternative, further embodiments could include that the subject device has a subject weight.

In addition to one or more of the features described above, or as an alternative, further embodiments could include that the first end of the passage is associated with a subject device dispenser.

In addition to one or more of the features described above, or as an alternative, further embodiments could include that the at least one urging member is at least one torsion spring.

In addition to one or more of the features described above, or as an alternative, further embodiments could include that the subject device is a sonobuoy.

In addition to one or more of the features described above, or as an alternative, further embodiments could include that the selective passive release mechanism is associated with an aircraft.

In addition to one or more of the features described above, or as an alternative, further embodiments could include urging the at least one hinged door closed via the at least one urging member in response to at least one of an aerodynamic force, and an aircraft acceleration.

Technical function of the embodiments described above includes at least one urging member to urge the at least one hinged door closed and to selectively open the at least one hinged door in response to the subject device contacting the at least one hinged door.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 is a schematic view of an aircraft for use with an embodiment of the invention;

FIG. 2 illustrates an isometric view of a release system in accordance with an embodiment of the invention;

FIG. 3 illustrates the release system of FIG. 2 with the doors of the release system in an open position; and

FIG. 4 illustrates a partial cross sectional view of the release system of FIG. 2.

### DETAILED DESCRIPTION OF THE INVENTION

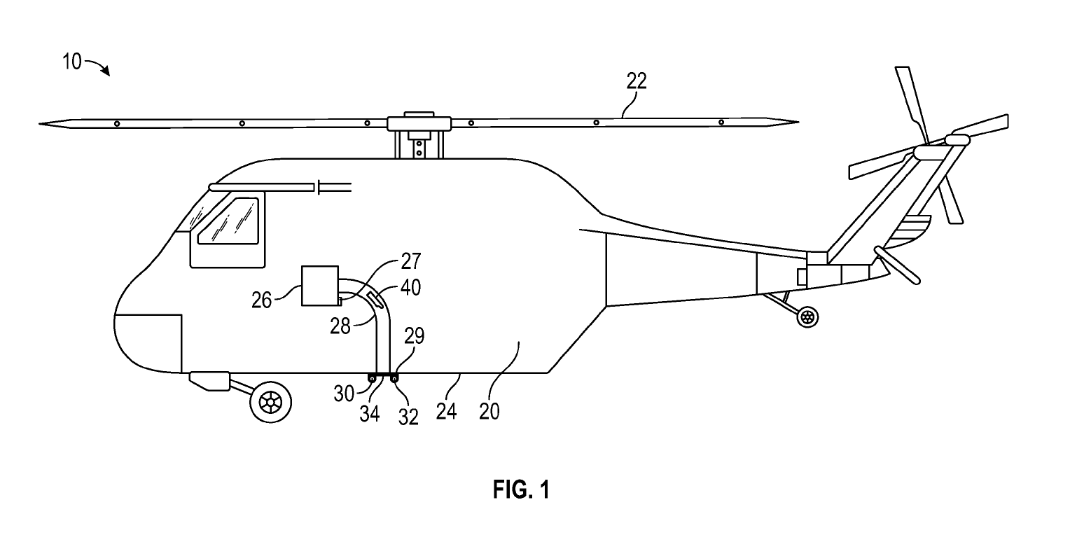

Referring now to the drawings, FIG. 1 illustrates a general schematic view of an aircraft 10 for use with a release system 30 suitable to release sonobuoys 40. In certain embodiments, aircraft 10 is a rotary wing aircraft 10 with a body 20, a rotor 22, and a release system 30 at least partially associated with the body 20. In an embodiment, aircraft 10 is an optionally piloted vehicle and can autonomously deploy devices via release system 30 autonomously. In certain embodiments, aircraft 10 can be any suitable aircraft, including fixed wing, rotary wing aircraft, etc.

Although a particular aircraft is illustrated and described in the disclosed embodiment, it will be appreciated that other configurations and/or machines including autonomous and optionally piloted aircraft that may operate in land or water including fixed-wing aircraft, rotary-wing aircraft, and land vehicles (e.g., trucks, cars, etc.) may also benefit from embodiments disclosed.

In an exemplary embodiment, aircraft 10 can contain sonobuoys 40 or any other suitable subject deployable device. Sonobuoys 40 can be deployed from an aircraft 10 and activated upon impact or otherwise reaching a destination. In an exemplary embodiment, sonobuoys 40 are deployed in bodies of water, and transmit sensor readings, such as acoustic readings to an aircraft 10 or other receiving location. In an exemplary embodiment, sonobuoys 40 have a characteristic or otherwise predetermined weight that can be used to calibrate or configure release system 30.

In an exemplary embodiment, sonobuoys 40, or other deployable devices are deployed from a dispenser 26. Dispenser 26 may be any suitable dispenser, including a rotary dispenser, etc. In certain embodiments, dispenser 26 can dispense one or more sonobuoys 40 at a desired time, altitude, or position along a flight plan. In certain embodiments, dispenser 26 may manually or automatically dispense sonobuoys 40 as required. In an exemplary embodiment, dispenser 26 is attached to a passage 28 to direct dispensed sonobuoys 40 outside of aircraft 10.

In an exemplary embodiment, passage 28 is a tubular member with a first or upper end 27 and a second or lower end 29. In other embodiments, passage 28 can be any suitable passage, including but not limited to any suitable shape, a cavity formed in aircraft body 20, etc. In certain embodiments, passage 28 can be a straight passage, while in other embodiments, passage 28 can include bends to accommodate the relative position of the dispenser 26 and the lower end 29. In an exemplary embodiment, the dispenser 26 is attached to dispense a sonobuoy 40 to upper end 27 of passage 28. Further, in an exemplary embodiment, the sonobuoy 40 travels through passage 28 to exit through lower end 29 of passage 28.

In an exemplary embodiment, release system 30 allows for a dispensed sonobuoy 40 in passage 28 to pass through release system 30, while otherwise closing or covering passage 28 when a sonobuoy 40 is not present. In an exemplary embodiment, release system 30 is associated with passage 28 to allow for coverage of lower end 29 of the passage 28. In certain embodiments, release system 30 can be associated with the upper end 27 of the passage 28, or any other suitable portion of passage 28. In an exemplary embodiment, the release system 30 and the lower end 29 of passage 28 are associated with the release surface 24 of the body 20. The release surface 24 can be any suitable surface of the body, including, but not limited to the lower portion of the body 20 to provide minimal disturbance to the trajectory of deployed sonobuoys 40.

Advantageously, release system 30 can prevent air flow disturbances over the release surface 24 during flight, while allowing for sonobuoys 40 to be deployed. Further, the passive and selective capabilities of release system 30 allow for lower cost operation, reduced complexity, and reduced weight.

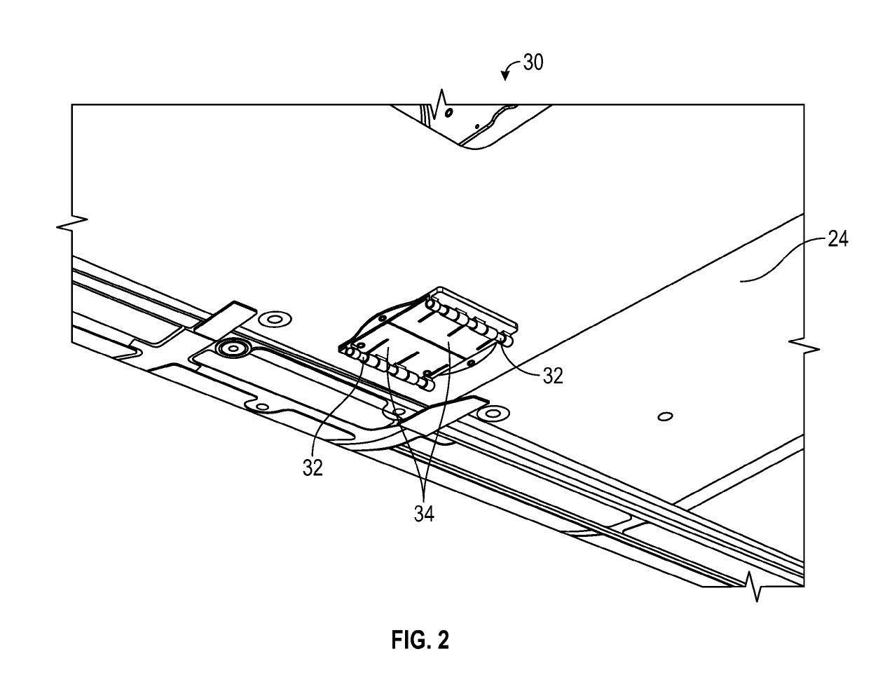

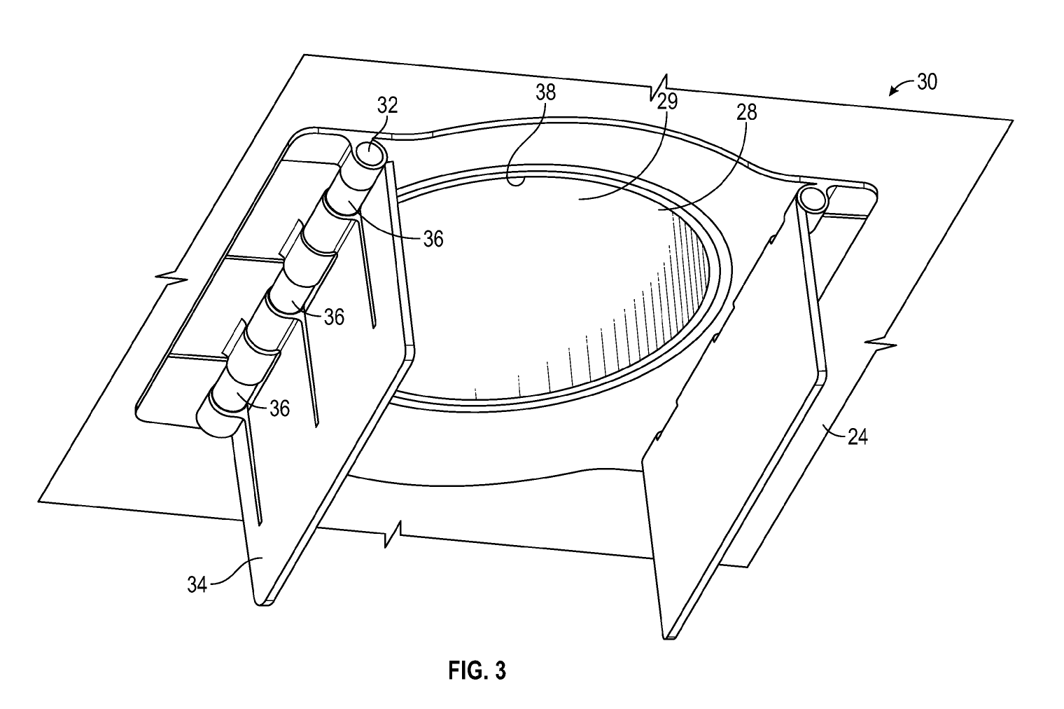

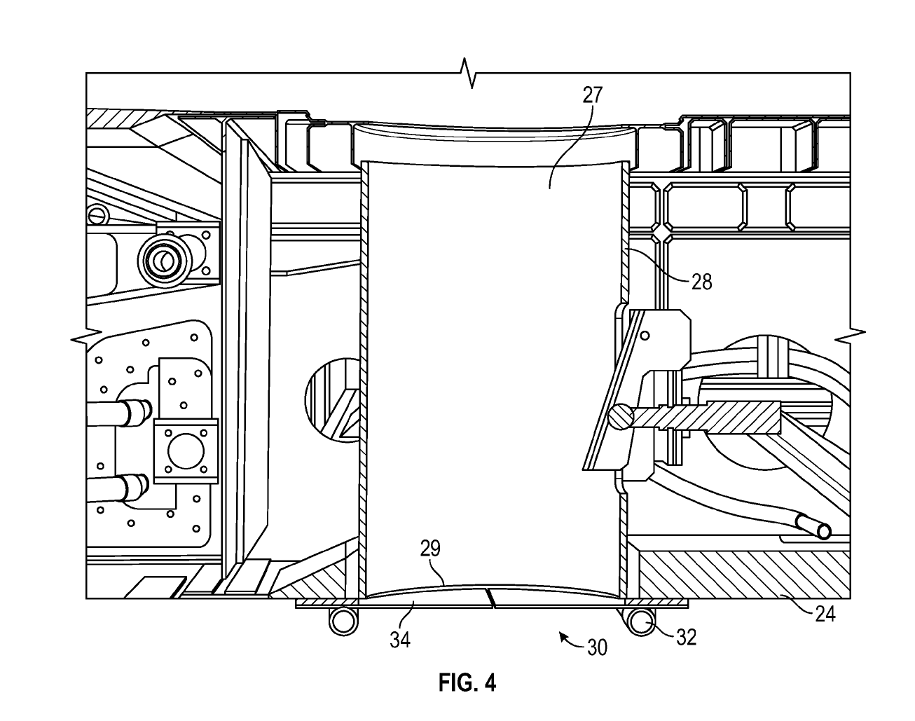

Referring to FIGS. 2-4, in an exemplary embodiment, release system 30 includes hinges 32 and doors 34. In an exemplary embodiment, release system 30 includes at least one door 34 and at least one associated hinge 32. In an exemplary embodiment, release system 30 includes two doors 34 and two hinges 32 associated with the two doors 34. In other embodiments, release system 30 includes any suitable number of doors 34 to obstruct or cover passage 28.

In an exemplary embodiment, doors 34 obstruct or cover passage 28 during normal operation. In certain embodiments, doors 34 also obstruct or cover release passage 38 associated with passage 28. In an exemplary embodiment, doors 34 allow passage of sonobuoy 40 without exposing passage 28 at any other time. In an exemplary embodiment, release device 30 includes two doors 34 that work in concert to obstruct or cover passage 28. In other embodiments, release device 30 can have any number of suitable doors. Doors 34 may be made of any suitable material, including metal, carbon fiber, composites, etc. In certain embodiments, doors 34 can have a sealing relationship with each other, passage 28, body 20, etc. In an exemplary embodiment, doors 34 are formed of a similar material as body 20 or release surface 24. In an exemplary embodiment, doors 34 are of a configured weight to allow hinges 32 and springs 36 to selectively and passively open doors 34 in response to the additional weight of a dispensed device, such as sonobuoy 40, such as when sonobuoy 40 contacts doors 34.

In an exemplary embodiment, doors 34 are connected to body 20 via hinges 32. In an exemplary embodiment, hinges 32 allow doors 34 to swing open to expose passage 28. In an exemplary embodiment, hinges 32 are associated with springs 36. In an exemplary embodiment, springs 36 are torsional springs. In an exemplary embodiment, springs 36 generally urge the doors 34 closed to obstruct or cover passage 28 when a sonobuoy 40 is not dispensed. In an exemplary embodiment, when a sonobuoy 40 is dispensed to passage 28, the contact weight of sonobuoy 40 in addition to the weight of the doors 34 overcomes the configured force of the springs 36 to open the doors 34 to allow a release of sonobuoy 40. In an exemplary embodiment, the characteristics of the springs 36 are selected to allow doors 34 to open when springs 36 are subjected to the additional weight of sonobuoy 40. Further, in an exemplary embodiment, the springs 36 are selected to urge the doors 34 closed during all portions of the flight envelope, including aerodynamic forces, high force inducing maneuvers, aircraft accelerations, etc. when the additional weight of a sonobuoy 40 is not present. After a sonobuoy 40 has passed, the force of the doors 34 and springs 36 is reduced, and the springs 36 urge the doors 34 shut.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. A selective passive release mechanism to release a subject device, the selective passive release mechanism comprising:
a passage associated with the subject device, the passage having a first end and a second end;
at least one hinged door associated with the second end of the passage; and at least one urging member to urge the at least one hinged door closed and to selectively open the at least one hinged door in response to the subject device contacting the at least one hinged door.

2. The selective passive release mechanism of claim 1, wherein the subject device has a subject weight.

3. The selective passive release mechanism of claim 1, wherein the first end of the passage is associated with a subject device dispenser.

4. The selective passive release mechanism of claim 1, wherein the at least one urging member is at least one torsion spring.

5. The selective passive release mechanism of claim 1, wherein the subject device is a sonobuoy.

6. The selective passive release mechanism of claim 1, wherein the selective passive release mechanism is associated with an aircraft.

7. The selective passive release mechanism of claim 1, wherein the at least one hinged door is urged closed by the at least one urging member in response to at least one of an aerodynamic force, and an aircraft acceleration.

8. A method for selectively releasing a subject device, the method comprising:
providing a passage associated with the subject device, the passage having a first end and a second end;
providing at least one hinged door associated with the second end of the passage; urging the at least one hinged door closed via at least one urging member;
selectively opening the at least one hinged door in response to the subject device contacting the at least one hinged door.

9. The method of claim 8, wherein the subject device has a subject weight.

10. The method of claim 8, wherein the first end of the passage is associated with a subject device dispenser.

11. The method of claim 8, wherein the at least one urging member is at least one torsion spring.

12. The method of claim 8, wherein the subject device is a sonobuoy.

13. The method of claim 8, wherein the selective passive release mechanism is associated with an aircraft.

14. The method of claim 8, further comprising urging the at least one hinged door closed via the at least one urging member in response to at least one of an aerodynamic force, and an aircraft acceleration.
